(19) United States
(12) Patent Application Publication
(10) Pub. No.: US 2013/0115529 A1
(43) Pub. Date: May 9, 2013

(54) ELECTROLYTE FOR METAL/AIR BATTERY

(71) Applicants: Shengshui Zhang, Olney, MD (US); Conrad Kang Xu, North Potomac, MD (US)

(72) Inventors: Shengshui Zhang, Olney, MD (US); Conrad Kang Xu, North Potomac, MD (US)

(73) Assignee: U.S. Government as represented by the Secretary of the Army, Adelphi, MD (US)

(21) Appl. No.: 13/418,395

(22) Filed: Mar. 28, 2012

Related U.S. Application Data
(60) Provisional application No. 61/556,894, filed on Nov. 8, 2011.

(51) Int. Cl. H01M 8/22; H01M 10/056; H01M 4/36

(52) U.S. Cl. 429/405; 429/403

(57) ABSTRACT

A series of fluorinated compounds are disclosed that can be used as the co-solvent of non-aqueous electrolytes for metal/air battery cells. The inclusion of these compounds in electrolyte systems significantly increases the power capability and energy capacity of metal/air batteries by promoting dissolution and increasing solubility of oxygen in the non-aqueous electrolytes.

### REFERENCE TO CO-PENDING AND ISSUED PATENTS

This application claims priority from U.S. provisional patent application No. 61/556,894, filed on 8 Nov. 2011. The entire disclosure of which is incorporated herein by reference. Attention is directed to commonly owned and assigned U.S. Pat. No. 7,833,660 issued Nov. 16, 2010, entitled “Fluorohaloborate Salts, Synthesis and Use Thereof”, wherein there is disclosed a composition well suited for inclusion within a lithium-ion battery; U.S. Pat. No. 7,842,802, issued Nov. 2, 2010, entitled “Method of Preparing a Composite Cathode Active Material For Rechargeable Electrochemical Cell”, wherein there is disclosed a method of preparing a composite cathode active material having superior cell characteristics includes mixing and milling starting material, carbon and an organic complexing agent; U.S. Pat. No. 7,820,323, issued Oct. 26, 2010, entitled “Metal Borate Synthesis Process”, wherein there is disclosed a novel liquid that upon reaction with lithium halide produces a lithium ion electrochemical device electrolyte upon dissolution in an aprotic solvent mixture; and U.S. Pat. No. 7,524,579, issued Apr. 28, 2009, entitled “Non-aqueous Solvent Electrolyte Battery With Additive Alkali Metal Salt Of A Mixed Anhydride Combination Of Oxalic Acid And Boric Acid”, wherein there is disclosed a method for enhancing the performance characteristics of a battery through the use of the electrolyte composition comprised of a nonaqueous solvent, and a salt mixture.

The disclosures of each of the above referenced patents and co-pending applications are incorporated herein by reference in their entirety.

### GOVERNMENT INTEREST

The invention described herein may be manufactured, used, and licensed by or for the United States Government.

### FIELD

The present invention relates to a non-aqueous electrolyte for a metal/air battery and in particular to a non-aqueous electrolyte that contains a fluorinated phosphorous compound.

### BACKGROUND

Metal/air or metal/oxygen batteries use oxygen from ambient air or in pure form as fuel to generate electrochemical energy. Since the oxygen is not included in a battery pack, such metal/air batteries theoretically have high energy densities. For example, a lithium/oxygen battery presents an approximate 13,000 Wh/kg of energy capacity, which is from about a five to about a tenfold increase over current state-of-the-art lithium-ion batteries. However, due to the high reactivity of lithium with water, traditional aqueous electrolytes used in metal/air batteries are riot suitable for lithium/air or lithium/oxygen batteries. Therefore, an electrolyte that is electrochemically stable, exhibits a low volatility, has fast oxygen dissolution and high oxygen solubility is desirable.

### SUMMARY

A non-aqueous electrolyte for a metal/air battery cell is provided. The non-aqueous electrolyte comprises a fluorinated phosphorous compound, the phosphorous of the fluorinated phosphorous compound having an oxidation state of +5. In embodiments, the fluorinated phosphorous compound has a functional group such as, for example, trifluoromethyl, trichloromethyl, 2,2,2-trifluoromethyl, 1,2,2-trifluoroethyl, perfluoroethyl, perfluoro-iso-propyl, 1,1,1,3,3,3-hexafluoro-2-propyl, perfluoro-tert-butyl or perfluorododecayl. In addition, the fluorinated phosphorous compound may comprise, for example, tris(2,2,2-trifluoromethyl)phosphate, tris(1,1,1,3,3,3-hexafluoro-2-propyl)phosphate, tris(perfluoroethyl)phosphate, tris(perfluoro-iso-propyl), (2,2,2-trifluoroethyl)-difluorophosphate), tris(1,2,2-trifluoroethyl)phosphate (TTFP), hexakis(2,2,2-trifluoroethoxy)phosphazene and tris(2,2,2-trifluoroethoxy)trifluorophosphazene.

The non-aqueous electrolyte comprises a co-solvent having a first solvent and a second solvent, the first solvent comprising, for example, a cyclic carbonate, an acyclic carbonate, a carboxylic ester, a cyclic ether, an acyclic ether, a cyclic sulfone, an acyclic sulfone, a cyclic sulfite, an acyclic sulfite, a cyclic nitrile, an acyclic nitrile, or combinations thereof. As such, the first solvent comprises, for example, EC (ethylene carbonate), PC (propylene carbonate), VC (vinylene carbonate), DMC (dimethyl carbonate), DEC (diethyl carbonate), EMC (ethyl methyl carbonate), FEC (fluoro ethylene carbonate), γ-butyrolactone, methyl butyrate, ethyl butyrate, diethylether, dimethyl ethoxyglycol, tetrahydrofuran, tetramethylene sulfone, ethylene sulfite, ethylmethyl sulfone, acetonitrile, thoxypropionitrile and combinations thereof.

The second solvent of the co-solvent may comprise, for example, the fluorinated phosphorous compound and have a functional group as listed above and/or be one of the compounds listed above. In addition, the co-solvent may comprise, for example, a salt that has an anion comprising, for example, hexafluorophosphate (PF₆), hexafluoroarsenate (AsF₆), perfluoroalkylfluorophosphate (P(CₙF₂ₙ₊₁)ₓF₆₋ₓ where 0≦n≦10 and 0≦x≦6), perfluoroalkylfluoroborate (B(CₙF2n+1)ₓF₄₋ₓ where 0≦n≦10 and 0≦x≦4), bis(trifluoromethanesulfonyl)imide, bis(perfluoroethanesulfonyl)imide, bis(oxalate)borate, (difluorooxalato)borate, BF₃X where X−F, Cl, Br or I, and combinations thereof.

### BRIEF DESCRIPTION OF THE DRAWINGS

FIG. 1 is a graphical representation of an electrochemical window for 0.2 m LiSO₃CF₃ 7:3 (wt.) PC/tris(2,2,2-trifluoroethyl)phosphate (TFP) electrolyte (hereafter PC/TFP) measured on a Platinum electrode at a potential scanning rate of 5 mV/s;

FIG. 2 is a graphical representation showing a comparison of discharge performances of: (1) Li/O₂ battery cell with a 0.2 m LiSO₃CF₃ 7:3 (wt.) PC/tris(2,2,2-trifluoroethyl)phosphite (TTFP) electrolyte (hereafter PC/TTFP); (2) Li/O₂ battery cell with 0.2 m LiSO₃CF₃ 7:3 (wt.) PC/TFP electrolyte; (1′) Li/air battery cell with a 0.2 m LiSO₃CF₃ 7:3 (wt.) PC/TTFP electrolyte; and (2′) Li/air battery cell with 0.2 m LiSO₃CF₃ 7:3 (wt.) PC/TFP) electrolyte;

FIG. 3 is a graphical representation illustrating a comparison of specific capacity of a Li/O₂ battery cell and a Li/air battery cells with 0.2 m LiSO₃CF₃(1-x):x PC/TFP electrolytes at a discharge rate of 0.2 mA/cm²; and

FIG. 4 is a graphical representation of discharge performances of Li/air battery cells with a 0.2 m LiSO₃CF₃ PC electrolyte (1), a 0.2 m LiSO₃CF₃ 7:3 PC/TTFP electrolyte (2), and a 0.2 m LiSO₃CF₃ 7:3 PC/TFP electrolyte (3) with: (A) a discharge rate of 0.1 m A/cm²; and (B) a discharge rate of 0.5 m A/cm².

### DETAILED DESCRIPTION

A non-aqueous electrolyte for a metal/air or metal/oxygen battery cell is provided. As such, the present invention has utility as a component for a battery cell.

As a primary aspect of the invention, the novel compounds of the present invention are constructed on the basis of the molecular compounds whose skeleton structures comprise, for example, structures 1 through 4 shown in Table 1. In embodiments, R₁, R₂, R₃, R₄, R₅ and R₆ designate substituents which can be identical or different from each other; which comprises hydrogen, hydroxyl, or halogen; which can be hydroxide salts with metal ions Of various valences, examples of which include, but are not limited to, Li⁺, Na⁺, ½Mg²⁺: ⅓Al³⁺, et cetera; which may comprise normal or branched alkyls with carbon number from 1 through 30, with or without unsaturation; which may comprise halogenated normal or branched alkyls with carbon number from 1through 30, with or without unsaturation; which may comprise partially halogenated or (fully halogenated) perhalogenated normal or branched alkyls with carbon number from 1through 30, with or without unsaturation; and/or which may comprise partially halogenated or perhalogenated normal or branched alkyls with carbon number from 1through 30, where the halogen substituents can be identical or different selected from F, Cl, Br or I, or mixture of all halogens.

TABLE 1

| | |
|---|---|
| 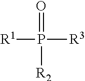 | (1) |
| 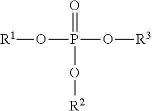 | (2) |
| 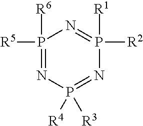 | (3) |
| 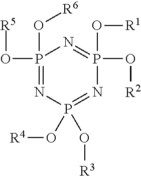 | (4) |

TABLE 2

| | |
|---|---|
| 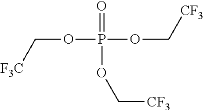 [SMILES: O=P(OCC(F)(F)F)(OCC(F)(F)F)OCC(F)(F)F] | (5) |
| 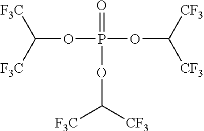 [SMILES: O=P(OC(C(F)(F)F)C(F)(F)F)(OC(C(F)(F)F)C(F)(F)F)OC(C(F)(F)F)C(F)(F)F] | (6) |
| 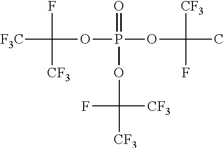 [SMILES: CC(F)(OP(=O)(OC(F)(C(F)(F)F)C(F)(F)F)OC(F)(C(F)(F)F)C(F)(F)F)C(F)(F)F] | (7) |
| 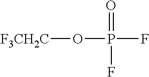 | (8) |
| 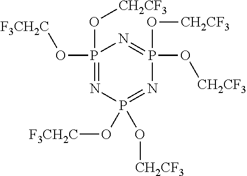 | (9) |
| 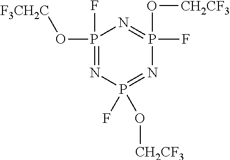 | (10) |

For example and for illustrative purposes only R¹, R², R³, R⁴, R⁵ and R⁶ may comprise trifluoromethyl, trichloromethyl, 2,2,2-trifluoroethyl, 1,2,2-trifluoroethyl, perfluoroethyl, perfluoro-iso-propyl, 1,1,1,3,3,3,-hexafluoro-2-propyl, perfluoro-/tert-butyl, perfluorododecayl, et cetera. As a way to illustrate, Table 2 illustratively lists selected compounds that are included in the compound families as described in Table 1.

In some instances, the novel compounds can be mixed with non-aqueous electrolyte solvents or solvent mixtures. In addition, the compounds can serve in the electrolyte either as major solvents, co-solvents at contents above about 10 percent by weight, or as additives at concentrations below about 10 percent by weight.

The non-aqueous electrolyte solvents may comprise, for example, carbonate esters such as ethylene carbonate (EC), propylene carbonate (PC), dimethylcarbonate (DMC), ethylmethylcarbonate (EMC), diethylcarbonate (DEC), 1-(trifluoromethyl)ethylene carbonate (CF₃-EC), monofluoro-ethylene carbonate (FEC), et cetera; organic acid esters such as alkyl carboxylates, lactones, et cetera; inorganic, acid esters such as alkyl sulfonates, alkyl sulfates, alkyl phosphonates, alkyl nitrates, et cetera; dialkyl ethers that are either symmetrical or unsymmetrical; and/or alkyl nitriles.

The non-aqueous electrolytes may comprise, for example, electrolyte solutes based on a cation and an anion. The cation selections comprise: alkali metal salts such as lithium (Li), sodium (Na), potassium (K), et cetera; alkali earth metal salts such as beryllium (Be), magnesium (Mg), calcium (Ca), et cetera: tetraalkylammonium or phosphonium (R₄N, R₄P). The anion selections comprise hexafluorophosphate (PF₆), hexafluoroarsenate (AsF₆), tetrafluoroborate (BF₄), perfluoroalkylfluorophosphate (PFₓR_{F(6-x)}), perfluoroalkylfluoroborate (BFₓR_{F(4-x)}), bis(trifluoromethanesulfonyl)borate ((CF₃SO₂)₂N), bis(perfluoroethanesulfonyl)imide ((CF₃CF₂SO₂)₂N), bis(oxalate)borate ((C₂O₄)₂B) and/or (difluorooxalato)borate (C₂O₄F₂B). It is appreciated that the salts can be selected by combining the above-mentioned cations and anions. In-addition, the electrolyte solutes can also be the novel compounds of the present invention for example at least one fluorinated molecular compound as illustrated in Table 1.

The novel compounds can include: tris(2,2,2-trifluoroethyl)phosphate (TFP, compound 5 in Table 2); tris(1,1,1,3,3,3-hexafluoro-2-propyl)phosphate (compound 6 in Table 2); (2,2,2-trifluoroethyl)-difluorophosphate (compound 8 in Table 2); tris(2,2,2-trifluoroethyl)phosphite (TTPF); hexakis(2,2,2-trifluoroethoxy)phosphazene (compound 9 in Table 2); and tris(2,2,2-trifluoroethoxy)trifluorophosphazene (compound 10 in Table 2), et cetera.

In embodiments, electrochemical devices that are filled with the novel electrolyte solution disclosed herein can be fabricated. For example, a metal/air electrochemical cell having: (1) an anode base on a metal, an alloy and the like (e.g. a lithium or lithium alloy anode); (2) an air cathode based on carbon or other conductive and porous materials without or with loading of an oxygen reduction catalyst; and (3) an electrolyte as described above that is either independent or immobilized with a separator can be fabricated.

It is appreciated that such an electrochemical cell can be assembled according to procedures readily known to those skilled in the art and the metal/air cell containing an electrolyte solution disclosed herein can enable chemistry of either a primary or rechargeable metal/air battery with enhanced energy and power densities, enhanced rate capabilities and enhanced durability in long term ambient environments.

Having described the invention, the following examples are given to illustrate specific applications and embodiment of the invention including the best mode now known to perform the invention. They are intended to provide those of ordinary skills in the art with a complete disclosure and description of how to make and use the novel solvents and additives of this invention. However, these specific examples are not intended to limit the scope of the invention described in this application.

### EXAMPLES

### Example 1

### Synthesis of tris(2,2,2-trifluoroethyl)Phosphate (TFP)

A quantity of 122.65 g (0.80 mole) phosphorus oxychloride (POCl₃, 99%) was added drop-wise to a mixture of 400 mL dry ethyl ether (99%), 253 g (2.50 mole) triethylamine (99%), and 250 g (2.50 mole) trifluoroethanol (99%) under vehement stirring at from about 0 to about 5 degrees Celsius. After the addition was completed, the mixture was refluxed for about one (1) hour. Ammonium salt was filtered and filtrate was washed by NaCl saturated distilled water. The resultant organic phase was dried over MgSO₄ and then fractionated 3 times. Final distillates of TFP of from about 188 to about 193 degrees Celsius were collected. The purified TFP was further dried over neutral alumina in a glove box before being used as an electrolyte solvent. Karl-Fischer titration indicated a from about 10 to about 15 parts per million moisture content and nuclear magnetic resonance (NMR) analysis of the TFP showed ¹H-NMR: 4.433 (quintuplet, J_{P-H}=8.002 Hz); ¹³C-NMR: 122.01 (octet, J_{C-P}=10.06 Hz, J_{C-F}=277.33 HZ); 64.261 (octet, J_{C-P}=4.276 Hz, J_{C-F}=38.61 Hz); ¹⁹F-NMR: −76.78 (triplet, J_{F-H}=8.00 Hz); and ³¹P-NMR: −2.538 (singlet).

### Example 2

### Electrolyte Preparation and Measurement of its Electrochemical Window

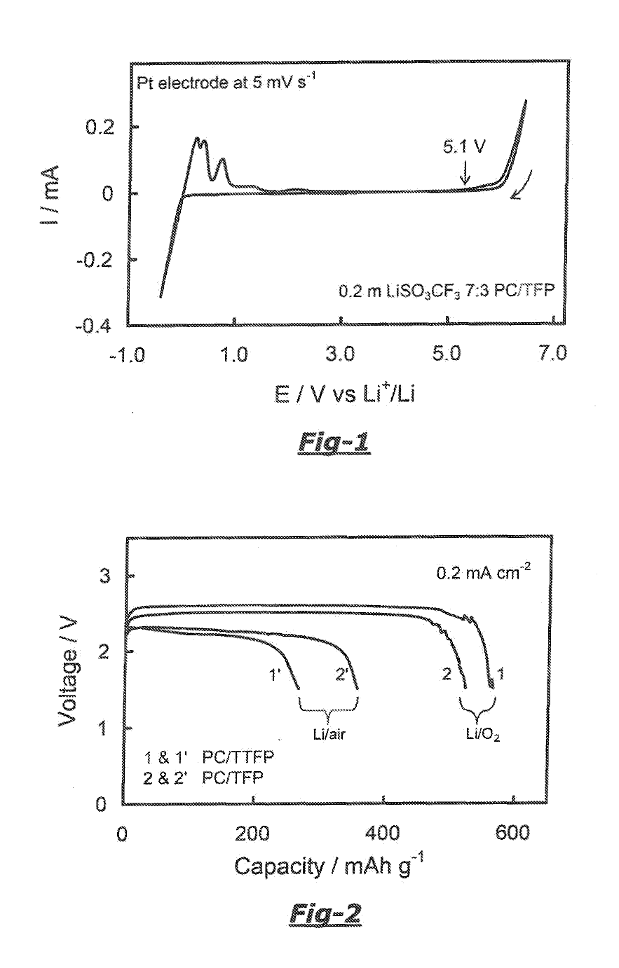

Commercially available propylene carbonate (PC), tris(2,2,2-trifluoroethyl)phosphite (TTFP), and tris(trifluoroethyl)Phosphate (TFP) synthesized as described in Example 1 were used as solvents with a series of electrolytes prepared in an argon-filled glove-box by dissolving a calculated amount of LiSO₃CF₃ into a solvent or solvent mixture. The electrochemical window of an electrolyte was measured using a platinum wire as the working electrode and two small pieces of lithium foil as the counter and reference electrodes. The platinum wire had a 1 centimeter length exposed to the electrolyte solution and a 0.5 millimeter diameter and a potential scanning rate of 5 mV/s was used. In addition, each scan (to anodic and cathodic) used a newly polished wire. FIG. 1 provides a graph showing an electrochemical window of at least 5.1 V exhibited by an electrolyte with a composition of 0.2 m LiSO₃CF₃ 7:33 (wt.) PC/TFP and thereby demonstrates that such an electrolyte could be suitable for rechargeable Li/air batteries.

### Example 3

### Fabrication of Li/O₂ Cell Arid Li/Air Cell

A carbon air electrode with a composition of 90 weight percent carbon (conductive carbon black) and 10 weight percent polytetrafluoroethylene (PTFE) was prepared by mixing calculated amounts of carbon with a PTFE emulsion (Teflon® solid content=61.5%) to make a paste, and then rolling the mixed paste into a free-standing cathode sheet. Small disks having an area of 0.97 cm² were punched out of the resultant cathode sheet and dried at about 100 degrees Celsius under vacuum for at least 8 hours. The air electrode typically had a thickness of from about 0.5 to about 0.6 mm and a porosity of 2.9-3.2 cm³/g.

Li/air cells with an air window of 0.97 cm² were assembled in a dry-room having a dew point below −90 degrees Celsius by stacking in sequence a Li foil, a Ceigard® 3500 membrane, a carbon air cathode, a nickel mesh as the current collector, and an air window into a coil cell cap. To activate a given cell, 200 micro liters (uL) of liquid electrolyte was added through the air-window, followed by applying a vacuum for 20 seconds to ensure complete wetting. In addition, any extra liquid electrolyte was removed by lightly swiping a filter paper on top of the nickel mesh.

The electrolyte-activated cell was clamped on a cell holder to discharge as a Li/air cell or sealed in an oxygen-filled plastic bag to discharge as a Li/O₂ cell. The cells were held inactive for 2 hours in order to allow oxygen concentrations in the air cathode and gaseous atmosphere in the cell to reach equilibrium. After the 2 hours had expired, discharging of the cell was performed on a cycler in a dry room. The discharge cutoff voltage was 1.5 V, and the specific capacity of a given cell was calculated based on the weight of carbon in the air cathode. All discharging tests were carried out at room temperature (22 degrees Celsius).

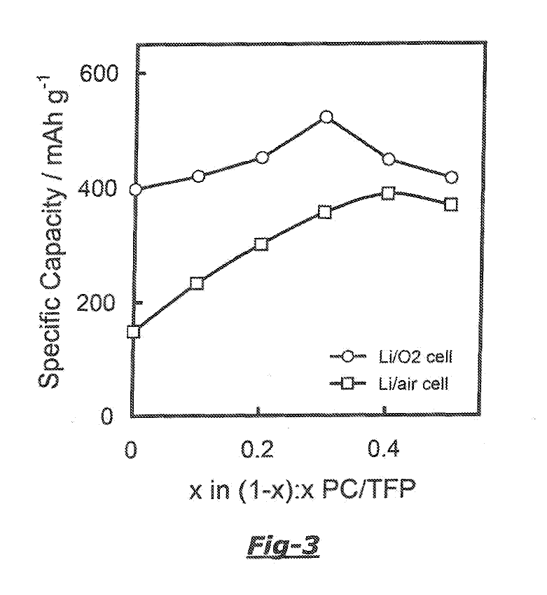

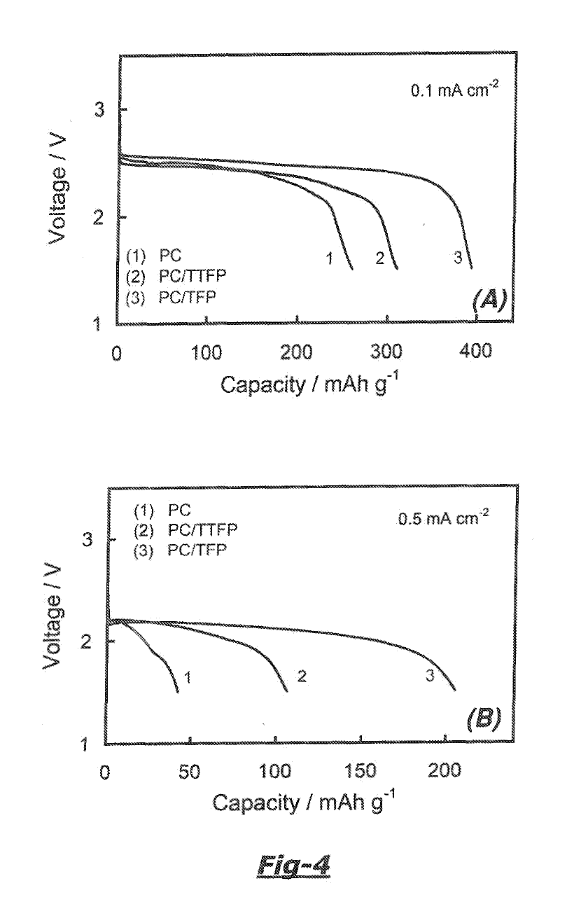

Turning now to FIG. 2, the graph in the figure illustrates that TFP electrolyte outperformed TTFP electrolyte in Li/air cells, but the opposite was true for Li/O₂ cells. Not being bound by theory, it is postulated that TFP with a +5 phosphorus valence is more suitable than TTFP for low oxygen partial pressure Li/air cells. FIG. 3 further indicates that the content of TFP in the non-aqueous electrolytes has an optimized range of approximately 30 percent by weight for a PC/TFP solvent system while FIG. 4 illustrates that at 0.1 mA/cm² and 0.5 mA/cm² discharge currents, Li/air cells with a TFP containing electrolyte outperforms Li/air cells with PC and PC/TTFP electrolytes. It is appreciated that this is especially true for the higher discharge current of 0.5 mA/cm².

The foregoing description is illustrative of particular embodiments of the invention, but it is not meant to be a limitation upon the practice thereof. The following claims, including all equivalents thereof, are intended to define the scope of the invention.

We claim:

1. A metal/air battery cell comprising:
a metal anode and an air cathode; and
a non-aqueous electrolyte containing a fluorinated phosphorous compound.

2. The metal/air battery cell of claim 1, wherein said phosphorous has an oxidation state of +5.

3. The metal/air battery cell of claim 2, wherein said fluorinated phosphorous compound has a functional group selected from the group consisting of trifluoromethyl, trichloromethyl, 2,2,2-trifluoromethyl, 1,2,2-trifluoroethyl, perfluoroethyl, perfluoro-iso-propyl, 1,1,1,3,3,3-hexafluoro-2-propyl, perfluoro-tert-butyl and perfluorododecayl.

4. The metal/air battery cell of claim 3, wherein said fluorinated phosphorous compound is at least one of tris(2,2,2-trifluoromethyl)phosphate, tris(1,1,1,3,3,3-hexafluoro-2-propyl)phosphate, tris(perfluoroethyl)phosphate, tris(perfluoro-iso-propyl), (2,2,2-trifluoroethyl)-difluorophosphate), tris(1,2,2-trifluoroethyl)phosphate (TTFP), hexakis(2,2,2-trifluoroethoxy)phosphazene and tris(2,2,2-trifluoroethoxy)trifluorophosphazene.

5. The metal/air battery cell of claim 4, wherein said metal anode contains lithium.

6. The metal/air battery cell of claim 1, wherein said non-aqueous electrolyte is a co-solvent having a first solvent and a second solvent, said first solvent selected from a group consisting of cyclic carbonates, acyclic carbonates, carboxylic esters, cyclic ethers, acyclic ethers, cyclic sulfones, acyclic sulfones, cyclic sulfites, acyclic sulfites, cyclic nitriles, acyclic nitriles and combinations thereof.

7. The metal/air battery cell of claim 6, wherein said first solvent is selected from a group consisting of EC (ethylene carbonate), PC (propylene carbonate), VC (vinylene carbonate), DMC (dimethyl carbonate), DEC (diethyl carbonate), EMC (ethyl methyl carbonate), FEC (fluoro ethylene carbonate), γ-butyrolactone, methyl butyrate, ethyl butyrate, diethylether, dimethyl ethoxyglycol, tetrahydrofuran, tetramethylene sulfone, ethylene sulfite, ethylmethyl sulfone, acetonitrile, thoxypropionitrile and combinations thereof.

8. The metal/air battery cell of claim 6, wherein said second solvent contains said fluorinated phosphorous compound.

9. The metal/air battery cell of claim 8, wherein said fluorinated phosphorous compound has a functional group selected from the group consisting of trifluoromethyl, trichloromethyl, 2,2,2-trifluoromethyl, 1,2,2-trifluoroethyl, perfluoroethyl, perfluoro-iso-propyl, 1,1,1,3,3,3-hexafluoro-2-propyl, perfluoro-tert-butyl and perfluorododecayl.

10. The metal/air battery cell of claim 9, wherein said fluorinated phosphorous compound is at least one of tris(2,2,2-trifluoromethyl)phosphate, tris(1,1,1,3,3,3-hexafluoro-2-propyl)phosphate, tris(perfluoroethyl)phosphate, tris(perfluoro-iso-propyl), (2,2,2-trifluoroethyl)-difluorophosphate), tris(1,2,2-trifluoroethyl)phosphate (TTFP), hexakis(2,2,2-trifluoroethoxy)phosphazene and tris(2,2,2-trifluoroethoxy)trifluorophosphazene.

11. The metal/air battery cell of claim 6, wherein said co-solvent contains a salt, said salt having an anion selected from a group consisting of hexafluorophosphate (PF₆), hexafluoroarsenate (AsF₆), perfluoroalkylfluorophosphate (P(CₙF₂ₙ₊₁)ₓF₆₋ₓ where 0≦n≦10 and 0≦x≦6), perfluoroalkylfluoroborate (B(CₙF₂ₙ₊₁)ₓF₄₋ₓ where 0≦n≦10 and 0≦x≦4), bis(trifluoromethanesulfonyl)imide, bis(perfluoroethanesulfonyl)imide, bis(oxalate)borate, (difluorooxalato)borate, BF₃X where X═F, Cl, Br or I, and combinations thereof.

12. An electrolyte for a metal/air battery cell, said electrolyte comprising:
a non-aqueous electrolyte containing a fluorinated phosphorous compound, said phosphorous having an oxidation state of +5.

13. The electrolyte of claim 12, wherein said fluorinated phosphorous compound has a functional group selected from the group consisting of trifluoromethyl, trichloromethyl, 2,2,2-trifluoromethyl, 1,2,2-trifluoroethyl, perfluoroethyl, perfluoro-iso-propyl, 1,1,1,3,3,3-hexafluoro-2-propyl, perfluoro-tert-butyl and perfluorododecayl.

14. The electrolyte of claim 13, wherein said fluorinated phosphorous compound is at least one of tris(2,2,2-trifluoromethyl)phosphate, tris(1,1,1,3,3,3-hexafluoro-2-propyl)phosphate, tris(perfluoroethyl)phosphate, tris(perfluoro-iso-propyl), (2,2,2-trifluoroethyl)-difluorophosphate), tris(1,2,2-trifluoroethyl)phosphate (TTFP), hexakis(2,2;2-trifluoroethoxy)phosphazene and tris(2,2,2-trifluoroethoxy)trifluorophosphazene.

15. The electrolyte of claim 12, wherein said non-aqueous electrolyte is a co-solvent having a first solvent and a second solvent, said first solvent selected from a group consisting of cyclic carbonates, acyclic carbonates, carboxylic esters, cyclic ethers, acyclic ethers, cyclic sulfones, acyclic sulfones, cyclic sulfites; acyclic sulfites, cyclic nitriles, acyclic nitriles and combinations thereof.

16. The electrolyte of claim 15, wherein said first solvent is selected from a group consisting of EC (ethylene carbonate), PC (propylene carbonate), VC (vinylene carbonate), DMC (dimethyl carbonate), DEC (diethyl carbonate), EMC (ethyl methyl carbonate); FEC (fluoro ethylene carbonate), γ-butyrolactone, methyl butyrate, ethyl butyrate, diethylether, dimethyl ethoxyglycol, tetrahydrofuran, tetramethylene sulfone, ethylene sulfite, ethylmethyl sulfone, acetonitrile, thoxypropionitrile and combinations thereof.

17. The electrolyte of claim 16, wherein said second solvent contains said fluorinated phosphorous compound.

18. The electrolyte of claim 17, wherein said fluorinated phosphorous compound has a functional group selected from the group consisting of trifluoromethyl, trichloromethyl, 2,2,2-trifluoromethyl, 1,2,2-trifluoroethyl, perfluoroethyl, perfluoro-iso-propyl, 1,1,1,3,3,3-hexafluoro-2-propyl, perfluoro-tert-butyl and perfluorododecayl.

19. The electrolyte of claim 18, wherein said fluorinated phosphorous compound is at least one of tris(2,2,2-trifluoromethyl)phosphate, tris(1,1,1,3,3,3-hexafluoro-2-propyl)phosphate, tris(perfluoroethyl)phosphate, tris(perfluoro-iso-propyl), (2,2,2-trifluoroethyl)-difluorophosphate), tris(1,2,2-trifluoroethyl)phosphate (TTFP), hexakis(2,2,2-trifluoroethoxy)phosphazene and tris(2,2,2-trifluoroethoxy)trifluorophosphazene.

20. The electrolyte of claim 19, wherein said co-solvent contains a salt, said salt having an anion selected from a group consisting of hexafluorophosphate (PF₆), hexafluoroarsenate (AsF₆), perfluoroalkylfluorophosphate (P(CₙF₂ₙ₊₁)ₓF₆₋ₓ where 0≦n≦10 and 0≦x≦6), perfluoroalkylfluoroborate (B(CₙF₂ₙ₊₁)ₓF₄₋ₓ where 0≦n≦10 and 0≦x≦4), bis(trifluoromethanesulfonyl)imide, bis(perfluoroethanesulfonyl)imide, bis(oxalate)borate, (difluorooxalato)borate, BF₃X where X═F, Cl, Br or I, and combinations thereof.
